(19) United States
(12) Patent Application Publication
(10) Pub. No.: US 2018/0307378 A1
(43) Pub. Date: Oct. 25, 2018

(54) WEARABLE DISPLAY, IMAGE DISPLAY APPARATUS, AND IMAGE DISPLAY SYSTEM

(71) Applicant: SONY CORPORATION, TOKYO (JP)

(72) Inventors: HIROTAKA ISHIKAWA, KANAGAWA (JP); TAKAFUMI ASAHARA, TOKYO (JP); TAKESHI IWATSU, KANAGAWA (JP); KEN SHIBUI, KANAGAWA (JP); KENJI SUZUKI, TOKYO (JP); TOMOHIDE TANABE, KANAGAWA (JP)

(21) Appl. No.: 15/769,093

(22) PCT Filed: Sep. 29, 2016
(86) PCT No.: PCT/JP2016/004330

§ 371 Date: Apr. 18, 2018

(30) Foreign Application Priority Data
Nov. 2, 2015 (JP) 2015-215524

(51) Int. Cl. G06F 3/0481; G06F 3/0484; G09G 5/38; H04N 5/64; G02B 27/02; G02B 27/01; G02B 27/00

(52) U.S. Cl. CPC G06F 3/0481; G06F 3/0484; G09G 5/38; G02B 27/0093; G02B 27/02; G02B 27/017; H04N 5/64

(57) ABSTRACT

A wearable display according to an embodiment of the present technology includes a display unit; a detection unit; and a display control unit. The display unit is configured to be attachable to a user, the display unit including a display area that provides a field of view in real space to the user. The detection unit detects orientation of the display unit around at least one axis. The display control unit is configured to be capable of presenting a first image relating to the orientation of the display unit in the display area on the basis of an output of the detection unit. The display control unit is configure to be capable of causing, depending on a change in the orientation, the first image to move in the display area in a direction opposite to a movement direction of the display unit by a first movement amount smaller than a movement amount of the display unit.

### TECHNICAL FIELD

The present technology relates to a wearable display, an image display apparatus, and an image display system that are capable of displaying an image including specific information in a display field of view.

### BACKGROUND ART

There is known a technology called augmented reality (AR), which adds, to real space or a screen that displays the real space, an image corresponding thereto. For example, in Patent Literature 1, a see-through head-mounted display (HMD) capable of superimposing, on a target object in real space, an image relating thereto (AR object) and display it is described.

### CITATION LIST

### Patent Literature

Patent Literature 1: WO 2014/128810

### DISCLOSURE OF INVENTION

### Technical Problem

In this type of head-mounted display, generally, the display position of an AR object is fixed to be attached to the target object, and the AR object is moved together with the target object in accordance with movement of a user's head. Therefore, for example, movement or fine shaking of the AR object following user's unconscious (unintended) movement impairs the visibility of the AR object in some cases. Further, a narrow display field of view makes the AR object outside the display area, and thus, the AR object is lost sight of in some cases.

In view of the circumstances as described above, it is an object of the present technology is to provide a wearable display, an image display apparatus, and an image display system that are capable of improving the visibility or searchability of an AR object.

### Solution to Problem

A wearable display according to an embodiment of the present technology includes a display unit, a detection unit, and a display control unit.

The display unit is configured to be attachable to a user, the display unit including a display area that provides a field of view in real space to the user.

The detection unit detects orientation of the display unit around at least one axis.

The display control unit is configured to be capable of presenting a first image relating to the orientation in the display area on the basis of an output of the detection unit. The display control unit is configured to be capable of causing, depending on a change in the orientation, the first image to move in the display area in a direction opposite to a movement direction of the display unit by a first movement amount smaller than a movement amount of the display unit.

In the wearable display, since the first image presented in the display area becomes difficult to move to the outside of the display area, it is possible to improve the searchability or visibility of the first image. Further, reduced movement of the first image with respect to unintended movement of the display unit makes it possible to improve the visibility of the first image.

The display control unit may control the first movement amount such that the first image is in the display area.

Accordingly, since it is possible to prevent the first image from moving to the outside of the display area, the visibility or searchability of the first image is ensured.

Alternatively, the display control unit may control the first movement amount such that the first movement amount is gradually reduced as the first image approaches an outside of the display area. Even with such a configuration, the visibility or searchability of the first image is ensured.

The first image may include information relating to a route to a destination set by the user.

Since such an image does not need strict accuracy regarding a presentation position in the display area, necessary information is reliably presented to a user even in the case where it is not moved by the amount of movement similar to that of the display unit.

Meanwhile, the first image may be a pattern authentication screen in which a plurality of keys are arranged in a matrix pattern. Alternatively, the first image may include a plurality of objects arranged in the display area, the user being capable of selecting the plurality of objects.

Accordingly, it is possible to easily perform an input operation by movement of a user.

The display control unit may be configured to be capable of presenting a second image in the display area on the basis of the output of the detection unit, the second image including information relating to a specific target object in real space in the orientation. In this case, the display control unit may be configured to be capable of causing, depending on the change in the orientation, the second image to move in the display area in the direction opposite to the movement direction of the display unit by a second movement amount larger than the first movement amount

Since such an image needs relatively strict accuracy regarding a presentation position in the display area, necessary information is reliably presented to a user by causing it to move by the amount of movement similar to that of the display unit.

An image display apparatus according to an embodiment of the present technology includes a display unit, a detection unit, and a display control unit.

The display unit includes a display area.

The detection unit detects orientation of the display unit around at least one axis.

The display control unit is configured to be capable of presenting a first image relating to the orientation in the display area on the basis of an output of the detection unit. The display control unit is configured to be capable of causing, depending on a change in the orientation, the first image to move in the display area in a direction opposite to a movement direction of the display unit by a first movement amount smaller than a movement amount of the display unit.

An image display system according to an embodiment of the present technology includes a display unit, a detection unit, and a display control unit.

The display unit includes a display area, and a reduction setting unit.

The detection unit detects orientation of the display unit around at least one axis.

The display control unit is configured to be capable of presenting a first image relating to the orientation in the display area on the basis of an output of the detection unit. The display control unit is configured to be capable of causing, depending on a change in the orientation, the first image to move in the display area in a direction opposite to a movement direction of the display unit by a first movement amount that is equal to or smaller than a movement amount of the display unit.

The reduction setting unit sets the first movement amount.

### Advantageous Effects of Invention

As described above, according to the present technology, it is possible to improve the visibility or searchability of an image of an AR object or the like.

It should be noted that the effect described here is not necessarily limitative and may be any effect described in the present disclosure.

### BRIEF DESCRIPTION OF DRAWINGS

FIG. 1 is a schematic diagram describing a function of a wearable display (HMD) according to an embodiment of the present technology.

FIG. 2 is a schematic diagram of a field of view presented in a display unit, which describes an example of the function of the HMD.

FIG. 3 is a schematic diagram of a field of view presented in a display unit, which describes an example of the function of the HMD.

FIG. 4 is a diagram showing the entire system including the HMD.

FIG. 5 is a block diagram showing a configuration of the system.

FIG. 6 is a functional block diagram of a control unit in the HMD.

FIG. 7A is a development view of cylindrical coordinates as an example of a world coordinate system in the HMD.

FIG. 7B is a development view of cylindrical coordinates as an example of the world coordinate system in the HMD.

FIG. 8 is a diagram describing a coordinate position in the cylindrical coordinate system.

FIG. 9 is a development view of the cylindrical coordinates, which conceptually shows a relationship between a field of view and an object.

FIG. 10A is a diagram describing a method of converting cylindrical coordinates (world coordinates) into a field of view (local coordinates).

FIG. 10B is a diagram describing a method of converting cylindrical coordinates (world coordinates) into a field of view (local coordinates).

FIG. 11A is a schematic diagram of a field of view, which shows a display example of an object.

FIG. 11B is a schematic diagram of a field of view when an object is caused to move around a yaw axis by normal rendering in FIG. 11A.

FIG. 11C is a schematic diagram of a field of view when an object is caused to move around a roll axis by normal rendering in FIG. 11A.

FIG. 12A is a schematic diagram of a field of view, which shows a display example of an object.

FIG. 12B is a schematic diagram of a field of view when an object is caused to move around a yaw axis by reduction rendering in FIG. 12A.

FIG. 12C is a schematic diagram of a field of view when an object is caused to move around a roll axis by reduction rendering in FIG. 12A.

FIG. 13A is a schematic diagram of a field of view, which shows a display example of an object.

FIG. 13B is a schematic diagram of a field of view when an object is caused to move around a roll axis by normal rendering in FIG. 13A.

FIG. 13C is a schematic diagram of a field of view when an object is caused to move around a roll axis by reduction rendering in FIG. 13A.

FIG. 14 is a diagram describing a method of calculating moved coordinates in reduction rendering of an object.

FIG. 15 is a flowchart describing an overview of an operation of the system.

FIG. 16 is a flowchart showing an example of rendering procedure of an object to a field of view by the control unit.

FIG. 17 is a schematic diagram of a field of view, which describes an example of application in the HMD.

FIG. 18A is a schematic diagram of a field of view, which describes an example of application in the HMD.

FIG. 18B is a schematic diagram of a field of view, which describes an example of application in the HMD.

FIG. 18C is a schematic diagram of a field of view, which describes an example of application in the HMD.

FIG. 19A is a schematic diagram of a field of view, which describes an example of application in the HMD.

FIG. 19B is a schematic diagram of a field of view, which describes an example of application in the HMD.

FIG. 20A is a schematic diagram of a field of view, which describes an example of application in the HMD.

FIG. 20B is a schematic diagram of a field of view, which describes an example of application in the HMD.

### MODE(S) FOR CARRYING OUT THE INVENTION

Hereinafter, embodiments of the present technology will be described with reference to the drawings.

### First Embodiment

[Schematic Configuration of AR System]

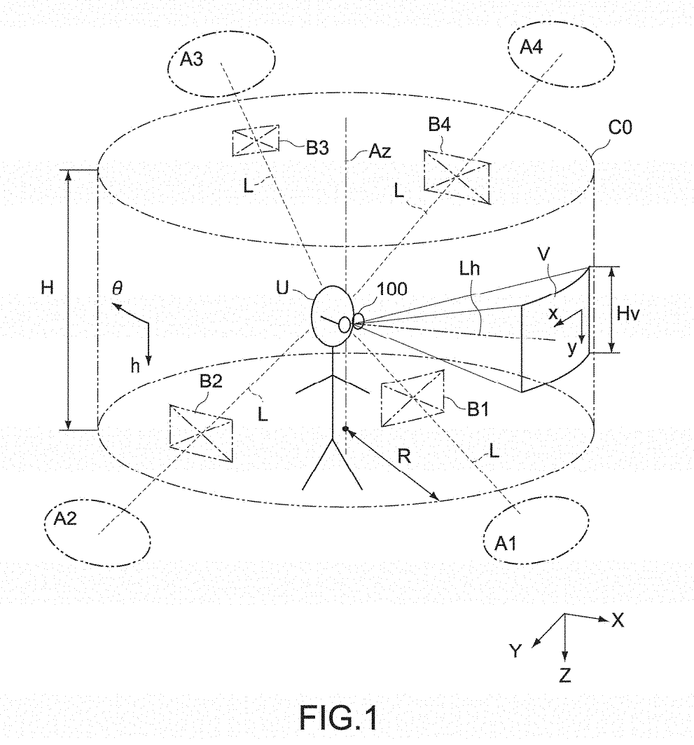

FIG. 1 is a schematic diagram describing a function of a head-mounted display (hereinafter, referred to as “HMD”) as a wearable display according to an embodiment of the present technology.

In FIG. 1, an X-axis direction and a Y-axis direction represent horizontal directions orthogonal to each other, and a Z-axis direction represent a vertical-axis direction. The XYZ orthogonal coordinate system represents a coordinate system (real three-dimensional coordinate system) of real space to which a user belongs. An arrow of the X-axis represents the North direction, and an arrow of the Y-axis represents the East direction. Further, an arrow of the Z-axis represents the gravity direction.

First, an overview of a basic function of an HMD 100 according to this embodiment will be described with reference to FIG. 1.

[Overview of Function of HMD]

The HMD 100 according to this embodiment is attached to the head of a user U, and is configured to be capable of displaying a virtual image (AR object, hereinafter, refereed to also as the object) in a field of view V (display field of view) in the real space of the user U. The object displayed in the field of view V includes information relating to a specific target object (A1, A2, A3, A4, . . . , hereinafter, collectively referred to as the specific target object A unless otherwise individually described) in the field of view V as well as information regarding those other than the specific target object A.

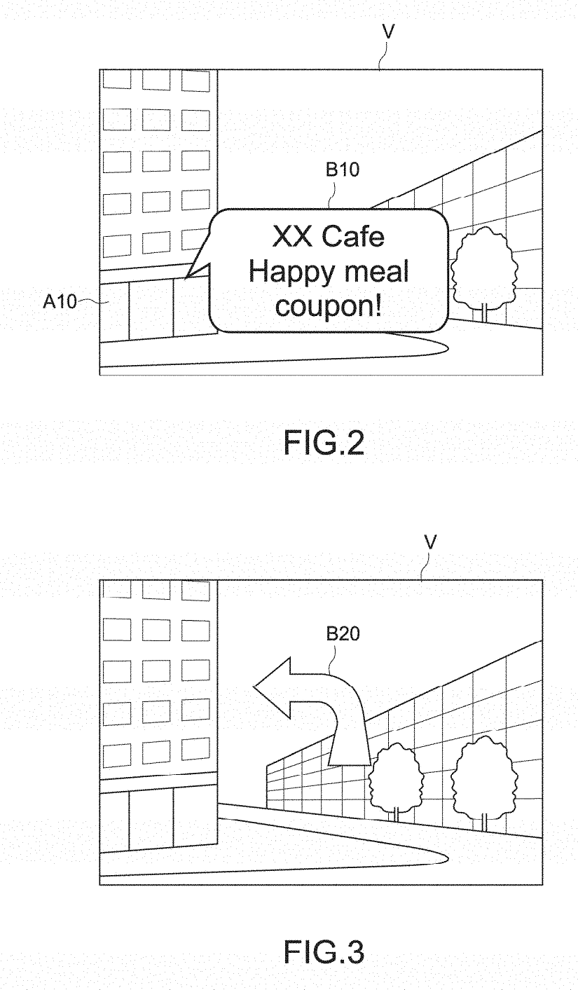

More specifically, for example, scenery, a shop, or a product around the user U corresponds to the specific target object A. As the information relating to the specific target object, an object B10 for informing that a specific coupon can be used in a specific shop A10 in the field of view V is displayed as schematically shown in FIG. 2. In the following description, such an object relating to the specific target object A in the field of view V will be referred to also as “the related object” (second image).

Meanwhile, for example, information relating to a route to a destination set by a user, or the like corresponds to information regarding those other than the specific target object A, and an object B 20 including an “arrow” or the like, which represents the traveling direction of a road or a passage regarding the orientation of a display unit 10, is displayed as schematically shown in FIG. 3. In addition, a menu screen for setting the function of the HMD 100 or a pattern authentication screen to be described later corresponds thereto. In the following description, such an object that is not related to the specific target object A in the field of view V and displays significant information by itself will be referred to also as “the individual object” (first image).

With reference to FIG. 1, the HMD 100 stores an object (B1, B2, B3, B4, . . . , hereinafter, collectively referred to as the object B unless otherwise individually described) associated with a virtual world coordinate system surrounding the user U wearing the HMD, in advance. The world coordinate system is a coordinate system equivalent to real space to which a user belongs, and determines a position of the specific target object A based on the position of the user U and a predetermined axial direction. In this embodiment, as the world coordinates, cylindrical coordinates C0 using a vertical axis as a central axis is employed. However, other than this, other three-dimensional coordinates such as celestial coordinates around the user U may be employed.

A radius R and a height H of the cylindrical coordinates C0 can be arbitrarily set. Here, the radius R is set to be shorter than the distance between the user U and the specific target object A. However, it may be set to be longer than the above-mentioned distance. Further, the height H is set to be equal to or higher than a height (length in the longitudinal direction) Hv of the field of view V of the user U provided via the HMD 100.

As described above, the object B includes information relating to the specific target object A in the above-mentioned world coordinate system, or information that is not related to the specific target object A. The object B may be an image including a character, a pattern, or the like, or may be an animation image. Further, the object B may be a two-dimensional image, or a three-dimensional image. Further, the shape of the object B may be a rectangular shape, a circular shape, or another arbitrary or significant geometric shape, and can be appropriately set depending on the type (attribution) of the object B or the display content.

The coordinate position of the object B on the cylindrical coordinates C0 is associated with an intersection position between a line of sight L of the user observing the specific target object A and the cylindrical coordinates C0, for example. In the example of FIG. 1, the central position of each of the objects B1 to B4 corresponds to the above-mentioned intersection position. However, it is not limited thereto, and a part (e.g., a part of the four corners) of the edge of each of the objects B1 to B4 may correspond to the above-mentioned intersection position. Alternatively, the coordinate position of each of the objects B1 to B4 may be associated with an arbitrary position away from the above-mentioned intersection position.

The cylindrical coordinates C0 include a coordinate axis (θ) in the circumferential direction representing an angle around the vertical axis with the North direction as 0°, and a coordinate axis (h) in the height direction representing an angle in the up-and-down direction based on a line of sight Lh of the user U in the horizontal direction. The coordinate axis (θ) regards the eastward as the positive direction, and the coordinate axis (h) regards the depression angle as the positive direction and the elevation angle as the negative direction.

As will be described later, the HMD 100 includes a detection unit for detecting the viewpoint direction of the user U, and determines, on the basis of the output of the detection unit, which area on the cylindrical coordinates C0 the field of view V of the user U corresponds to. Then, in the case where there is any object (e.g., the object B1) in the corresponding area of the xy coordinate system forming the field of view V, the HMD 100 presents (renders) the object B1 in the corresponding area of the field of view V.

As described above, the HMD 100 according to this embodiment presents information relating to the target object A1 to the user U by superimposing the AR object B1 on the specific target object A1 in real space and displaying the AR object B1 in the field of view V. Further, the HMD 100 presents the AR objects (B1 to B4) relating to the specific target objects A1 to A4 to the user U depending on the viewpoint orientation or viewpoint direction of the user U.

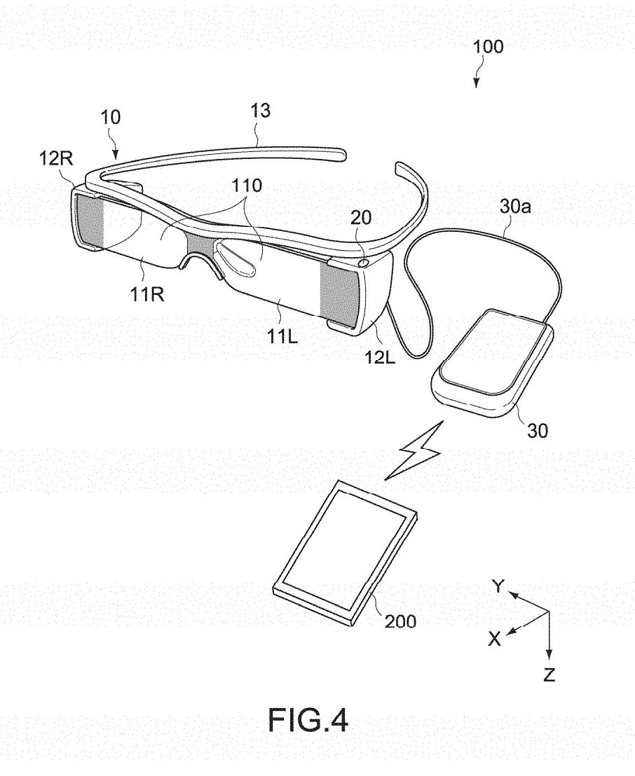

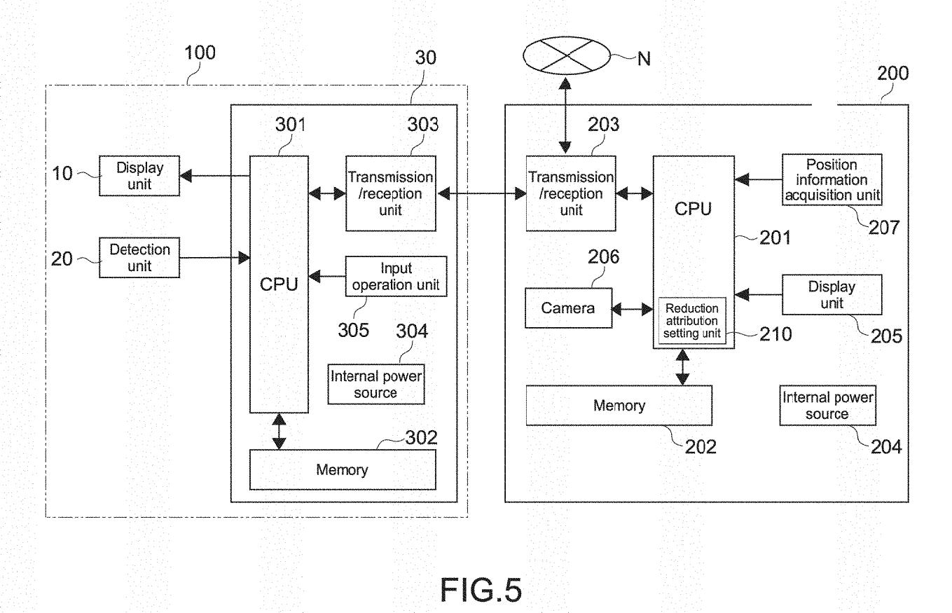

Next, details of the HMD 100 will be described. FIG. 4 is a diagram showing the entire HMD 100, and FIG. 5 is a block diagram showing a configuration thereof.

[Configuration of HMD]

The HMD 100 includes the display unit 10, a detection unit 20 that detects posture of the display unit 10, a control unit 30 that controls driving of the display unit 10. In this embodiment, the HMD 100 includes a see-through HMD capable of providing the field of view V in real space to the user.

(Display Unit)

The display unit 10 is configured to be attachable to the head of the user U. The display unit 10 includes first and second display surfaces 11R and 11L, first and second image generation units 12R and 12L, and a supporting body 13.

The first and second display surfaces 11R and 11L each include an optical device that includes a light transmissive display area 110 capable of providing a field of view in real space (outside field of view) to the right eye and the left eye of the user U, respectively. The first and second image generation units 12R and 12L are configured to be capable of generating images to be presented to the user U via the first and second display surfaces 11R and 11L, respectively. The supporting body 13 supports the display surfaces 11R and 11L and the image generation units 12R and 12L, and has an appropriate shape that is attachable to the head of the user so that the first and second display surfaces 11L and 11R respectively face the right eye and the left eye of the user U.

The display unit 10 configured as described above is capable of providing the field of view V on which a predetermined image (or virtual image) is superimposed in real space to the user U via the display surfaces 11R and 11L. In this case, the cylindrical coordinates C0 for the right eye and the cylindrical coordinates C0 for the left eye are set, and an object rendered in each of the cylindrical coordinates is projected on the display area 110 of the display surfaces 11R and 11L.

(Detection Unit)

The detection unit 20 is configured to be capable of detecting the change in orientation or posture of the display unit 10 around at least one axis. In this embodiment, the detection unit 20 is configured to detect the change in orientation or posture around the X, Y, and Z axes of the display unit 10.

Note that the orientation of the display unit 10 typically represents the front direction of the display unit 10. In this embodiment, the orientation of the display unit 10 is defined as the orientation of the face of the user U.

The detection unit 20 may include a motion sensor such as an angular velocity sensor and an acceleration sensor, or a combination thereof. In this case, the detection unit 20 may include a sensor unit in which angular velocity sensors and acceleration sensors are arranged in triaxial directions, or the sensor to be used may be changed for each axis. For the change in posture of the display unit 10, the direction of the change, the change amount, and the like, the integral value of the output of the angular velocity sensor can be used, for example.

Further, for detection of the orientation of the display unit 10 around the vertical axis (Z axis), a geomagnetic sensor may be used. Alternatively, a geomagnetic sensor and the above-mentioned motion sensor may be combined with each other. Accordingly, it is possible to detect the change in orientation or posture of the display unit 10 with high accuracy.

The detection unit 20 is disposed at an appropriate position in the display unit 10. The position of the detection unit 20 is not particularly limited, and is disposed at, for example, any one of the image generation units 12R and 12L or a part of the supporting body 13.

(Control Unit)

The control unit 30 generates, on the basis of an output of the detection unit 20, a control signal for controlling driving of the display unit 10 (image generation units 12R and 12L). In this embodiment, the control unit 30 is electrically connected to the display unit 10 via a connection cable 30a. It goes without saying that it is not limited thereto, and the control unit 30 may be connected to the display unit 10 via a wireless communication line.

As shown in FIG. 5, the control unit 30 includes a CPU 301, a memory 302 (storage unit), a transmission/reception unit 303, an internal power source 304, and an input operation unit 305.

The CPU 301 controls the operation of the entire HMD 100. The memory 302 includes a ROM (Read Only Memory), a RAM (Random Access Memory), and the like, and stores a program for executing the control of the HMD 100 by the CPU 301, various parameters, an image (object) to be displayed on the display unit 10, and other necessary data. The transmission/reception unit 303 constitutes an interface for communicating with a portable information terminal 200 to be described later. The internal power source 304 supplies power necessary for driving the HMD 100.

The input operation unit 305 is for controlling an image to be displayed on the display unit 10 via a user operation. The input operation unit 305 may include a mechanical switch or a touch sensor. The input operation unit 305 may be provided to the display unit 10.

The HMD 100 may further include an audio output unit such as a speaker, a camera, and the like. In this case, the above-mentioned audio output unit and camera are typically provided to the display unit 10. Further, to the control unit 30, a display device that displays an input operation screen for the display unit 10, or the like may be provided. In this case, the input operation unit 305 may include a touch panel provided to the display device.

(Portable Information Terminal)

The portable information terminal 200 is configured to be capable of communicating with the control unit 30 via a wireless communication line. The portable information terminal 200 has a function of acquiring an image (object) to be displayed on the display unit 10 and a function of transmitting the acquired image (object) to the control unit 30. By organically combining the portable information terminal 200 with the HMD 100, an HMD system (image display system) is established.

The portable information terminal 200 is carried by the user U who wears the display unit 10, and includes an information processing apparatus such as a personal computer (PC), a smartphone, a cellular phone, a tablet PC, and a PDA (Personal Digital Assistant). However, the portable information terminal 200 may include a terminal apparatus dedicated to the HMD 100.

As shown in FIG. 5, the portable information terminal 200 includes a CPU 201, a memory 202, a transmission/reception unit 203, an internal power source 204, a display unit 205, a camera 206, and a position information acquisition unit 207.

The CPU 201 controls the operation of the entire portable information terminal 200. The memory 202 includes a ROM, a RAM, and the like, and stores a program for executing the control of the portable information terminal 200 by the CPU 201, various parameters, an image (object) to be transmitted to the control unit 30, and other necessary data. The internal power source 204 supplies power necessary for driving the portable information terminal 200.

The transmission/reception unit 203 communicates with a server N, the control unit 30, another neighboring portable information terminal, and the like by using a wireless LAN (IEEE802.11 or the like) such as WiFi (Wireless Fidelity) and a network such as 3G or 4G network for mobile communication. The portable information terminal 200 downloads an image (object) to be transmitted to the control unit 30 or an application for displaying the image (object) from the server N via the transmission/reception unit 203, and stores the image (object) in the memory 202.

The display unit 205 includes, for example, an LCD or OLED, and displays a GUI of the like of various menus or applications. Typically, the display unit 205 is formed integrally with a touch panel, and is capable of receiving a user's touch operation. The portable information terminal 200 is configured to be capable of inputting a predetermined operation signal to the control unit 30 by a touch operation of the display unit 205.

The position information acquisition unit 207 typically includes a GPS (Global Positioning System) receiver. The portable information terminal 200 is configured to be capable of measuring the present position (longitude, latitude, and height) of the user U (display unit 10) by using the position information acquisition unit 207, and acquiring a necessary image (object) from the server N. That is, the server N acquires information relating to the present position of the user, and transmits the image data, application software, or the like depending on the position information to the portable information terminal 200.

The server N typically includes a computer including a CPU, a memory, and the like, and transmits predetermined information to the portable information terminal 200 in response to a request from the user U or automatically regardless of the intention of the user U. The server N stores a plurality of types of image data that can be displayed by the HMD 100. The server N is configured to be capable of collectively or successively transmitting, to the portable information terminal 200, a plurality of pieces of image data selected depending on the position of the user U, operation, or the like, as part of the above-mentioned predetermined information.

(Details of Control Unit)

Next, details of the control unit 30 will be described.

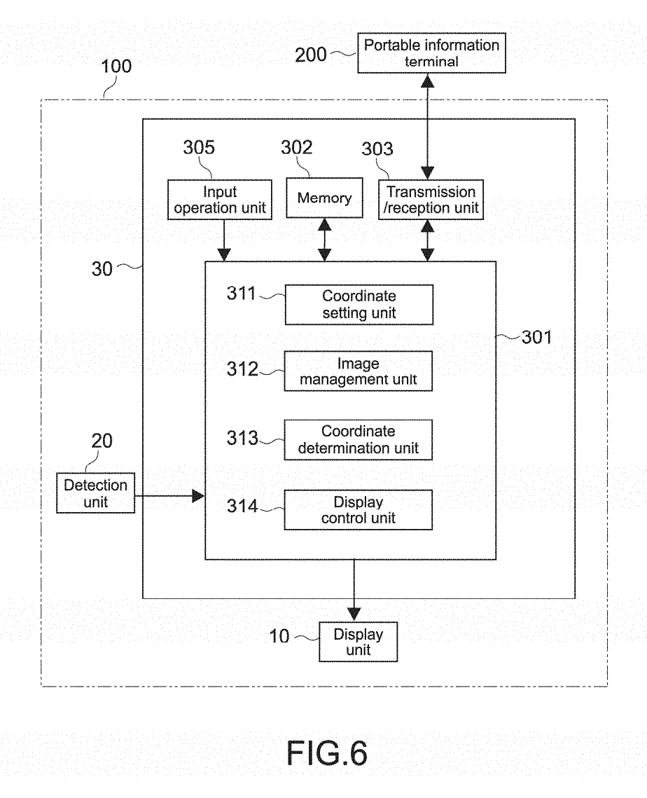

FIG. 6 is a functional block diagram of the CPU 301. The CPU 301 includes a coordinate setting unit 311, an image management unit 312, a coordinate determination unit 313, and a display control unit 314. The CPU 301 executes processing in the coordinate setting unit 311, the image management unit 312, the coordinate determination unit 313, and the display control unit 314 in accordance with the program stored in the memory 302.

The coordinate setting unit 311 is configured to execute processing of setting three-dimensional coordinates surrounding the user U (display unit 10). In this example, as the above-mentioned three-dimensional coordinates, the cylindrical coordinates C0 (see FIG. 1) using a vertical axis Az as a center are used. The coordinate setting unit 311 sets the radius R and the height H of the cylindrical coordinates C0. The coordinate setting unit 311 typically sets the radius R and the height H of the cylindrical coordinates C0 depending on the number, type, or the like of objects to be presented to the user U.

The radius R of the cylindrical coordinates C0 may have a fixed value, or a variable value that can be arbitrarily set depending on the size (pixel size) of the image to be displayed, or the like. The height H of the cylindrical coordinates C0 is set to, for example, one to three times the size of the height Hv (see FIG. 1) in the longitudinal direction (vertical direction) of the field of view V provided to the user U by the display unit 10. The upper limit of the height H is not limited to the three times of the Hv, and may exceed the three dimes of the Hv.

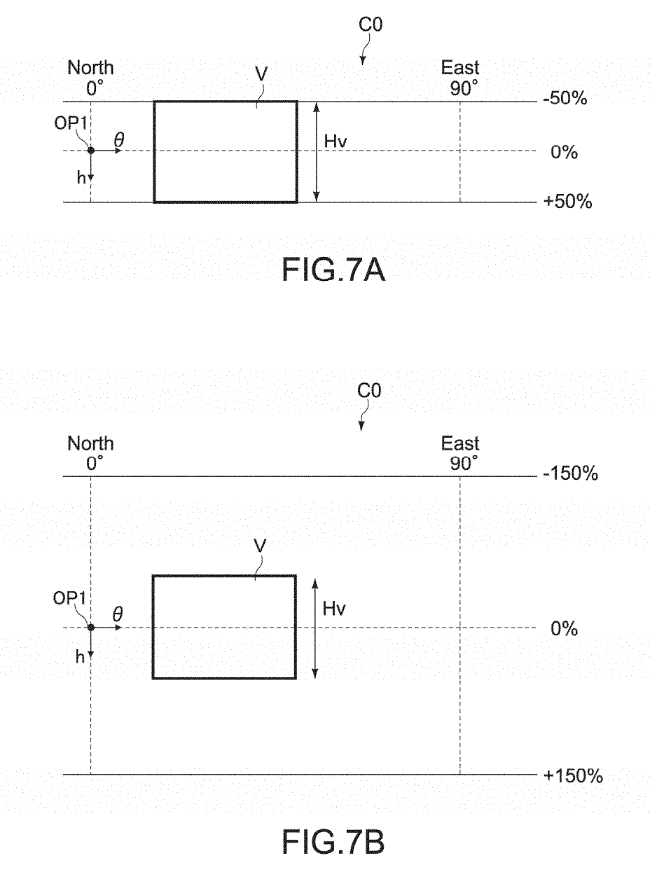

FIG. 7A and FIG. 7B are each a schematic diagram showing the developed cylindrical coordinates C0. In particular, FIG. 7A shows the cylindrical coordinates C0 having a height H1 that is the same as the height Hv of the field of view V, and FIG. 7B shows the cylindrical coordinates C0 having a height H2 that is three times as the height Hv of the field of view V.

As described above, the cylindrical coordinates C0 include the coordinate axis (θ) in the circumferential direction representing an angle around the vertical axis with the North direction as 0°, and the coordinate axis (h) in the height direction representing an angle in the up-and-down direction based on the line of sight Lh of the user U in the horizontal direction. The coordinate axis (θ) regards the eastward as the positive direction, and the coordinate axis (h) regards the depression angle as the positive direction and the elevation angle as the negative direction. The height H represents the size with the size of the height Hv of the field of view V as 100%, and an origin OP1 of the cylindrical coordinates C0 is set to an intersection point between the orientation (0°) in the North direction and the line of sight Lh (h=0%) of the user U in the horizontal direction.

The image management unit 312 has a function of managing an image stored in the memory 302, and is configured to execute, for example, processing of storing one or more images to be displayed via the display unit 10 in the memory 302 and processing of selectively deleting the image stored in the memory 302. The image to be stored in the memory 302 is transmitted from the portable information terminal 200. Further, the image management unit 312 requests, via the transmission/reception unit 303, the portable information terminal 200 to transmit an image.

The memory 302 is configured to be capable of storing one or more images (objects) to be displayed on the field of view V, in association with the cylindrical coordinates C0. That is, the memory 302 stores the respective objects B1 to B4 on the cylindrical coordinates C0 shown in FIG. 1 together with the coordinate positions on the cylindrical coordinates C0.

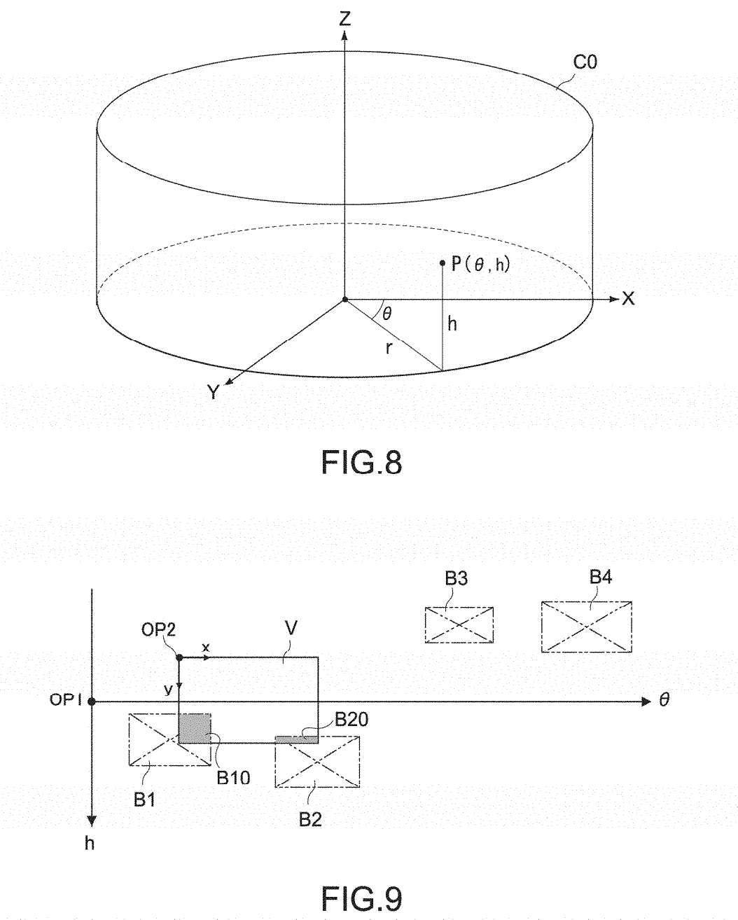

As shown in FIG. 8, a cylindrical coordinate system (θ, h) and the orthogonal coordinate system (X, Y, Z) have a relationship that X=r cos θ, Y=r sin θ, and Z=h. As shown in FIG. 1, the objects B1 to B4 to be displayed corresponding to the orientation or posture of the field of view V occupy respective unique coordinate areas on the cylindrical coordinates C0, and are stored in the memory 302 together with a specific coordinate position P(θ, h) in the area.

The coordinates (θ, h) of each of the objects B1 to B4 on the cylindrical coordinates C0 is associated with coordinates in the cylindrical coordinate system of an intersection point between a line that connects the respective positions of the target objects A1 to A4 defined in the orthogonal coordinate system (X, Y, Z) and the position of the user and a cylindrical surface of the cylindrical coordinates C0. That is, the coordinates of the objects B1 to B4 respectively correspond to the coordinates of the target objects A1 to A4 converted from the real three-dimensional coordinates to the cylindrical coordinates C0. Such conversion of the coordinates of the object is executed in, for example, the image management unit 312, and each object is stored in the memory 302 together with the coordinate position. By employing the cylindrical coordinates C0 for the world coordinate system, it is possible to planarly render the objects B1 to B4.

The coordinate positions of the objects B1 to B4 may be set to any position in the display area of the objects B1 to B4. For one object, the coordinate position may be set to one specific point (e.g., central position), or two or more points (e.g., diagonal two points or points at the four corners)

Further, as shown in FIG. 1, in the case where the coordinate positions of the objects B1 to B4 are associated with the intersection positions between the line of sight L of the user observing the target objects A1 to A4 and the cylindrical coordinates C0, respectively, the user U visually confirms the objects B1 to B4 at the positions that overlap with the target objects A1 to A4. Instead of this, the coordinate positions of the objects B1 to B4 may be associates with arbitrary positions away from the intersection positions. Accordingly, it is possible to display or render the objects B1 to B4 at desired positions with respect to the target objects A1 to A4.

The coordinate determination unit 313 is configured to execute processing of determining, on the basis of the output of the detection unit 20, which area on the cylindrical coordinates C0 the field of view V of the user U corresponds to. That is, the field of view V moves on the cylindrical coordinates C0 in accordance with the change in posture of the user U (display unit 10), and the moving direction or the movement amount is calculated on the basis of the output of the detection unit 20. The coordinate determination unit 313 calculates the movement direction and movement amount of the display unit 10 on the basis of the output of the detection unit 20, and determines which area on the cylindrical coordinates C0 the field of view V belongs to.

FIG. 9 is a development view of the cylindrical coordinates C0, which conceptually shows a relationship between the field of view V and the objects B1 to B4 on the cylindrical coordinates C0. The field of view V has a substantially rectangular shape, and has xy coordinates (local coordinates) with the upper left corner as an origin OP2. The x axis is an axis extending from the origin OP2 in the horizontal direction, and the y axis is an axis extending from the origin OP2 in the vertical direction. Then, the coordinate determination unit 313 is configured to execute processing of determining whether or not there is any of the objects B1 to B4 in the corresponding area of the field of view V.

The display control unit 314 is configured to execute processing of displaying (rendering), on the field of view V, the object on the cylindrical coordinates C0 corresponding to the orientation of the display unit 10 on the basis of the output of the detection unit 20 (i.e., determination result of the coordinate determination unit 313). For example, as shown in FIG. 9, in the case where the present orientation of the field of view V overlaps with the display areas of the objects B1 and B2 on the cylindrical coordinates C0, images corresponding to the areas B10 and B20 with which the objects B1 and B2 overlap are displayed (local rendering) on the field of view V.

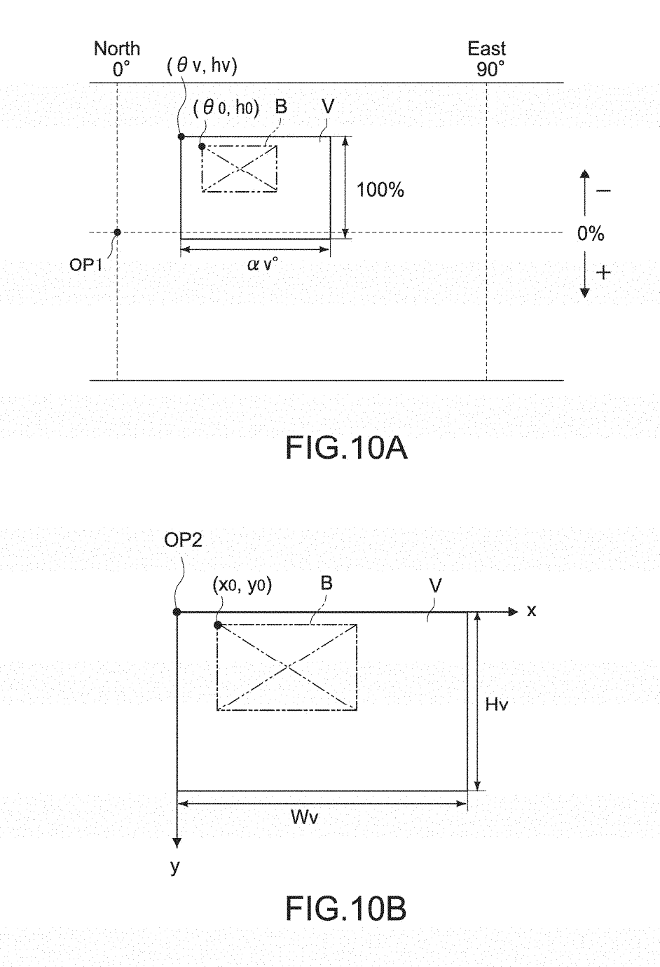

FIG. 10A and FIG. 10B are each a diagram describing a method of converting the cylindrical coordinates C0 (world coordinates) into the field of view V (local coordinates).

As shown in FIG. 10A, assumption is made that the reference point of the field of view V on the cylindrical coordinates C0 has coordinates (θv, hv), and the reference point of the object B located in the area of the field of view V has coordinates (θ0, h0). The reference points of the field of view V and the object B may be set to any point, and are set to the left corners of the rectangular field of view V and the rectangular object B in this example, respectively. The αv[° ] represents a width angle of the field of view V on the world coordinates, and the value thereof is determined by the design or specification of the display unit 10.

The display control unit 314 determines the display position of the object B in the field of view V by converting the cylindrical coordinate system (θ, h) into the local coordinate system (x, y). When the height and width of the field of view V in the local coordinate system are represented by Hv and Wv, and the coordinates of the reference point of the object B in the local coordinate system (x, y) are represented by (x0, y0), respectively, as shown in FIG. 10B, the conversion formulae are as follows.

x0=(θ0−θv)·Wv/αv (1)

y0=(h0−hv)·Hv/100 (2)

The display control unit 314 causes the object B to move in the direction opposite to the above-mentioned moving direction of the display unit 10 in the field of view V depending on the change in orientation of the display unit 10. That is, the display control unit 314 changes the display position of the object B in the field of view V by following the change in orientation or posture of the display unit 10. This control is continued as long as there is at least a part of the object B in the field of view V.

(Reduction Setting of Individual Object)

In this embodiment, the display control unit 314 causes the object (related object B10, see FIG. 2) including information relating to the specific target object in the field of view V to move in the direction opposite to the moving direction of the display unit 10 in the field of view V by the same movement amount (second movement amount) as the movement amount of the display unit 10 depending on the movement (change in orientation, or the like) of the display unit 10.

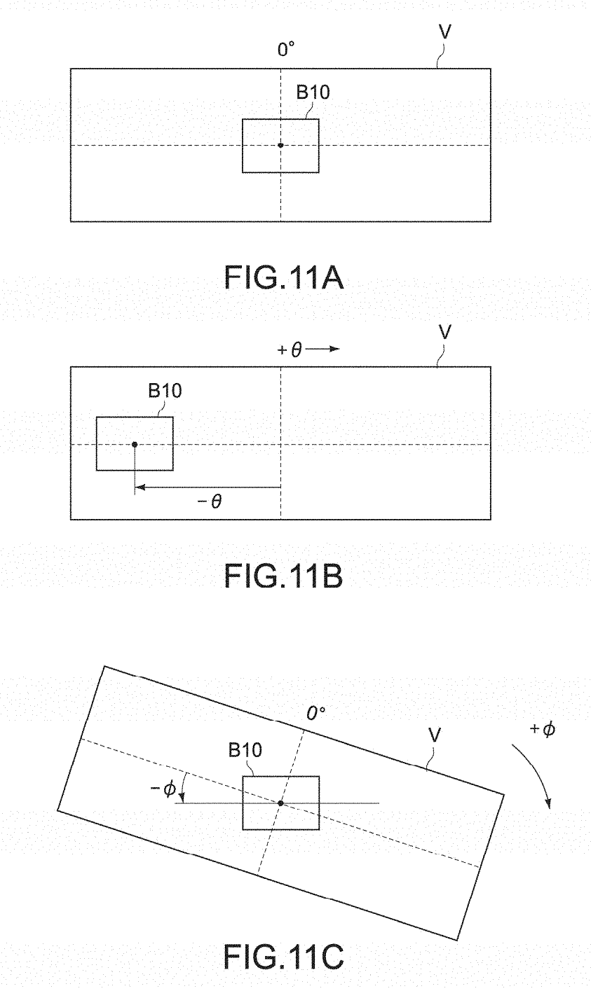

For example, in the case where the display unit 10 is caused to move rightward by the amount corresponding to an angle θ (+θ) around the yaw axis (Z axis in FIG. 4) while the related object B10 is displayed at the center of the field of view V as shown in FIG. 11A, the display control unit 314 causes the related object B10 to move leftward from the center of the field of view V by the amount corresponding to an angle θ (−θ) as shown in FIG. 11B. Similarly, in the case where the display unit 10 rotates in a clockwise direction around the roll axis (X axis in FIG. 4) by an angle φ (+φ), the display control unit 314 causes the related object B10 to rotate in a counterclockwise direction around the field of view V by the amount corresponding to an angle φ (−φ) as shown in FIG. 11C.

By causing the movement amount of the specific target object B10 to correspond to the movement amount of the display unit 10 as described above, the relative position between the specific target object and the object relating thereto is held. Accordingly, the user U is capable of easily determining which specific target object the object (information) relating to.

Meanwhile, in this embodiment, the display control unit 314 causes the object (individual object B20, see FIG. 2) including information that is not related to the specific target object in the field of view V to move in the direction opposite to the moving direction of the display unit 10 in the field of view V by the movement amount (first movement amount) smaller than the movement amount of the display unit 10 depending on the movement (change in orientation, or the like) of the display unit 10.

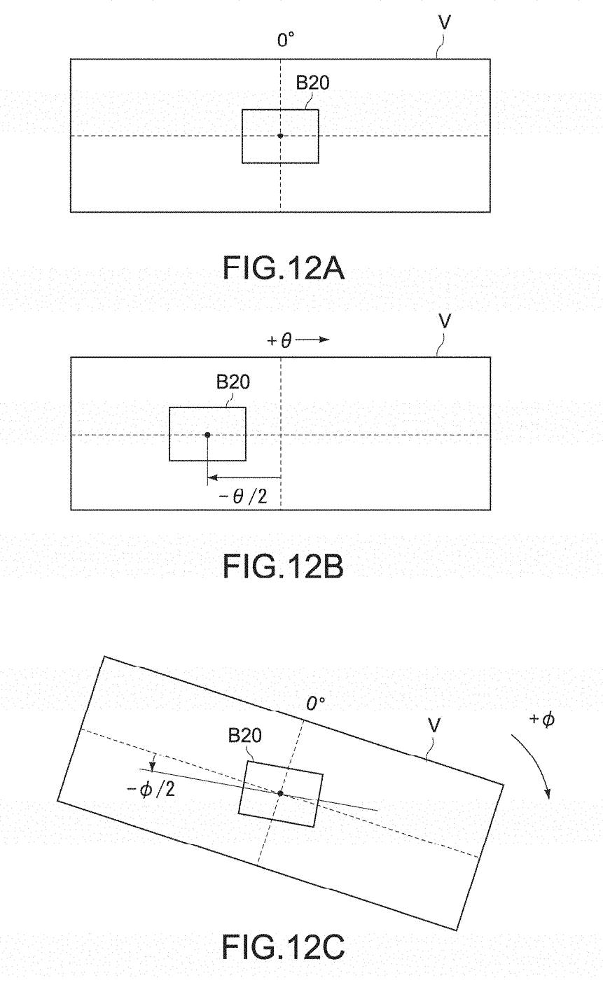

For example, in the case where the display unit 10 is caused to move rightward around the above-mentioned yaw axis by the amount corresponding to an angle θ (+e) while the individual object B20 is displayed at the center of the field of view V as shown in FIG. 12A, the display control unit 314 causes the individual object B20 to move leftward from the center of the field of view V by the amount corresponding to, for example, an angle θ/2 (−θ/2) as shown in FIG. 12B. Similarly, in the case where the display unit 10 rotates in a clockwise direction around the above-mentioned roll axis by the amount corresponding to, for example, an angle φ (+φ), the display control unit 314 causes the individual object B20 around the field of view V in a counterclockwise direction by the amount corresponding to, for example, an angle φ/2 (−φ/2) as shown in FIG. 12C.

By executing control of reducing the movement of the individual object B20 with respect to the movement of the display unit 10 as described above, the individual object B20 becomes difficult to move to the outside of the field of view V (display area 110) even in the case where the movement of the display unit 10 is relatively large. Therefore, in whatever direction the user turns his/her face, the visibility of the object is ensured. Such control is effective particularly in performing display control of the individual object B20 relating to navigation information shown in FIG. 3, for example.

Note that the display control that reduces the movement of the individual object as described above is applicable not only to the movement of the display unit 10 around the yaw axis and the roll axis but also to the movement around the pitch axis (Y axis in FIG. 4) orthogonal thereto, similarly.

The movement amount of the individual object B20 is not particularly limited as long as it is smaller than the movement amount of the display unit 10. Therefore, the movement amount of the individual object B20 is not limited to half the amount of the display unit 10 as shown in FIGS. 12B and 12C, and may be larger or smaller than that.

The display control unit 314 may control the movement amount of the individual object B20 so that the individual object B20 is within the field of view V (display area 110). Accordingly, since it is possible to prevent the individual object B20 from moving to the outside of the field of view, the visibility or searchability of the individual object B20 is ensured.

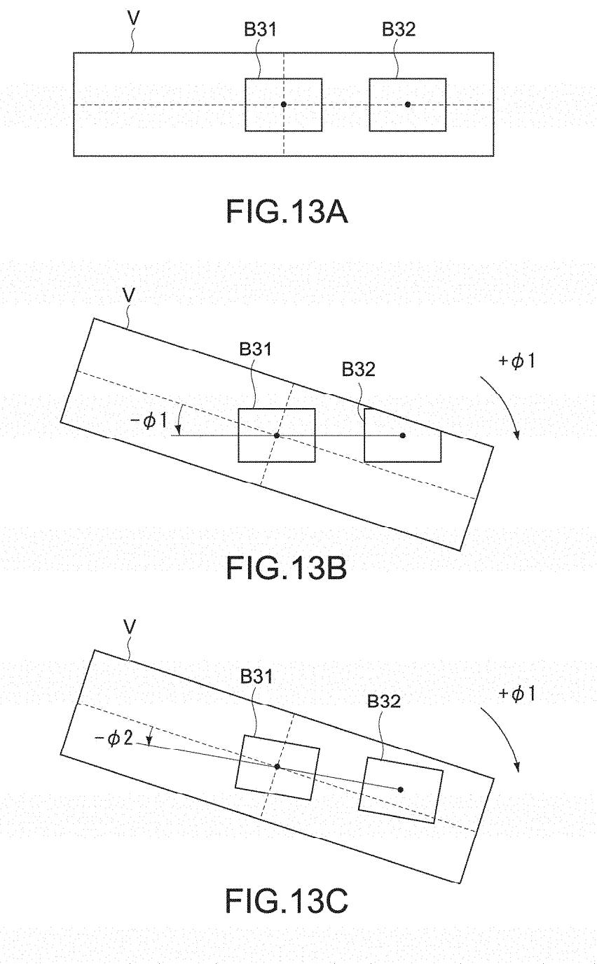

For example, a case where when the display unit 10 rotates around the roll axis while a plurality of objects B31 and B32 are displayed in the field of view V as shown in FIG. 13A, the display control unit 314 causes the plurality of objects B31 and B32 to rotate in the direction opposite to the rotation direction of the display unit 10 around the field of view V by following the movement of the display unit 10 will be considered. At this time, in the case where the objects B31 and B32 are the related objects, the display control unit 314 causes the objects B31 and B32 to move by a movement amount (p1) equivalent to the movement amount of the display unit 10 as shown in FIG. 13B. Therefore, depending on the movement amount, a part or all of the object moves to the outside of the field of view V in some cases.

Meanwhile, in the case where the objects B31 and B32 are the individual objects, the display control unit 314 causes the objects B31 and B32 to rotate by a movement amount (φ2) in which the object B32 displayed on the outermost periphery side of the turning radius is within the field of view V as shown in FIG. 13C. In this case, the display of the objects B31 and B32 may be controlled so that the movement amount of the object B32 is gradually reduced as the object B32 approaches the outside of the field of view V. Alternatively, the display of the objects B31 and B32 may be controlled so that the movement amount thereof is gradually reduced as the objects B31 and B32 get away from a predetermined reference position. Such display control is applicable not only to the movement of the display unit 10 around the roll axis but also to the movement around the yaw axis and the pitch axis, similarly.

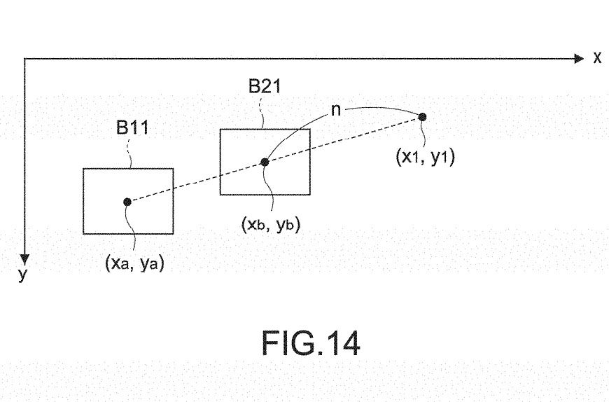

FIG. 14 is a schematic development view of cylindrical coordinates, which describes a method of calculating reduction coordinates of an individual object around the yaw axis and the pitch axis of the display unit 10 as an example.

In FIG. 14, when the central coordinates of the field of view V are represented by (x1, y1) and the moved coordinates of the center of a related object B11 are represented by (xa, ya), the moved coordinates (xb, yb) of the center of an individual object B21 on which reduction control is to be performed can be represented by the following formulae.

xb=(1−n)x1+nxa (3)

yb=(1−n)y1+nya (4)

In the formulae (3) and (4), n is a reduction rate, and the range of the value thereof satisfies the relationship that 0<n1. In the case where reduction control is not executed (case of no reduction setting) as in the related object B11, n=1. In the case where reduction control is executed as in the individual object B21, it is set to an arbitrary value that satisfies the relationship that 0<n<1. For example, in the case where the movement amount of the individual object is half the movement amount of the related object as shown in FIGS. 12B and 12C, n=0.5 (reduction rate of 50%), and the degree of reduction is increased as the value of n is decreased.

In this embodiment, the reduction setting of the individual object is typically performed by the portable information terminal 200. That is, the portable information terminal 200 has a function as a reduction setting unit that sets the reduction attribution of the movement amount (first movement amount) of the individual object with respect to the movement amount of the display unit 10.

A reduction attribution setting unit 210 is constituted of the CPU 201 of the portable information terminal 200, as shown in FIG. 5. The reduction attribution setting unit 210 sets, depending on attributions (e.g., types of objects such as a related object and an individual object.) of various objects received from the server N, the reduction rate of each of these objects.

The reduction attribution setting unit 210 typically disables the reduction attribution (n=1) with respect to the related object, and sets a predetermined reduction rate (e.g., n=0.5) as the reduction attribution with respect to the individual object. The reduction rate to be set on the individual object does not necessarily need to be the same, and may differ depending on the application or the type of the individual object.

Note that valid reduction attributions may be set on all the objects regardless of the attributions of the objects. Further, by the user selection, whether the reduction attribution is valid or invalid may be selected, or the reduction rate may be set, for each object. In this case, a setting input of the reduction attribution may be performed via the display unit 205 of the portable information terminal 200.

[Operation of HMD]

Next, an example of an operation of an HMD system including the HMD 100 according to this embodiment configured as described will be described.

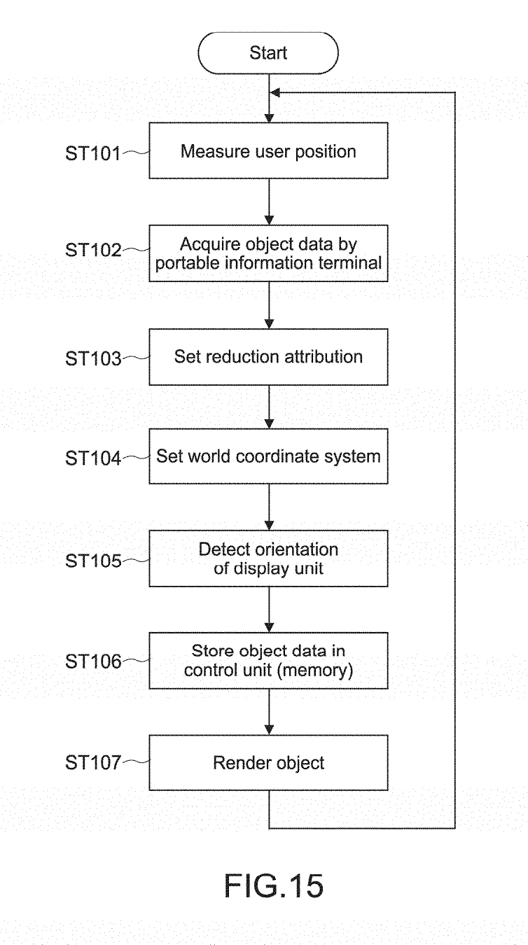

FIG. 15 is a flowchart describing an overview of an operation of the HMD system according to this embodiment.

First, the present position of the user U (display unit 10) is measured by using the position information acquisition unit 207 of the portable information terminal 200 (Step 101). The position information of the display unit 10 is transmitted to the server N. Then, the portable information terminal 200 acquires, from the server N, object data relating to a predetermined target object in real space surrounding the user U (Step 102). Then, on the acquired object data, the reduction setting unit 210 sets the validity/invalidity of the reduction setting, the value of the reduction rate (n), and the like (Step 103).

Next, the portable information terminal 200 notifies the control unit 30 of that preparation to transmit the object data is finished. The control unit 30 (coordinate setting unit 311 in this example) sets a height (H) and a radius (R) of the cylindrical coordinates C0 as the world coordinate system depending on the type or the like of the object data (Step 104). In this case, in the case where an area control function depending on the height (Hv) of the field of view V provided by the display unit 10 is valid, the coordinate setting unit 311 sets the world coordinate system to, for example, the cylindrical coordinates C0 shown in FIG. 7A.

Next, the control unit 30 the orientation of the field of view V on the basis of the output of the detection unit 20 (Step 105), acquires the object data from the portable information terminal 200, and stores it in the memory 302 (Step 106). The orientation of the field of view V is converted into the world coordinate system (θ, h), and which position on the cylindrical coordinates C0 it corresponds to is monitored.

Then, in the case where there is object data in the corresponding area in the field of view V on the cylindrical coordinates C0, the control unit 30 displays (renders) the object at the corresponding position in the field of view V via the display unit 10 (Step 107).

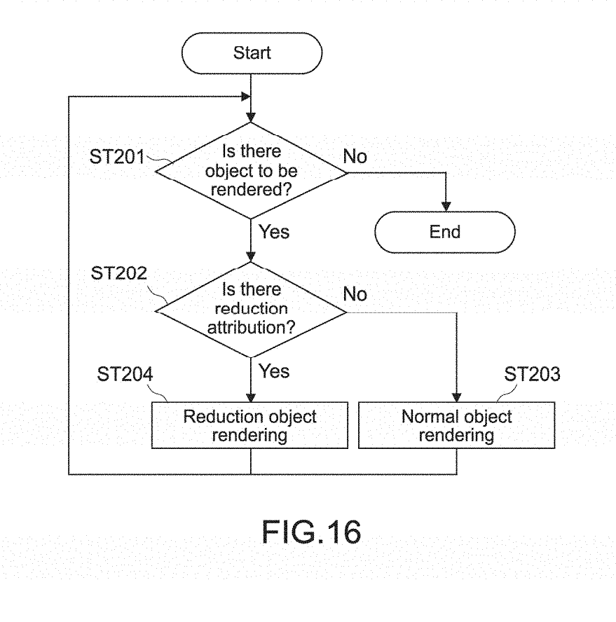

FIG. 16 is a flowchart showing an example of rendering procedure of an object to the field of view V by the control unit 30.

The control unit 30 determines whether or not there is an object to be rendered in the field of view V, on the basis of the output of the detection unit 20 (Step 201). For example, in the case where there is a specific target object in the field of view V, it is determined that an object (related object) relating to the specific target object is the “object to be rendered”. Alternatively, when a navigation mode is being executed, it is determined that an object (individual object) relating to route information is the “object to be rendered”.

Next, the control unit 30 determines whether or not there is setting of the reduction attribution of the “object to be rendered” (Step 202). Typically, it is determined that a related object has “no reduction attribution”, and an individual object has a “reduction attribution”. Then, the control unit 30 (display control unit 314) presents the former object in the field of view V by normal control in which it is caused to move by the same movement amount as the movement amount of the display unit 10 (Step 203, normal object rendering), and presents the latter object in the field of view V by reduction control in which it is caused to move by the movement amount smaller than the movement amount of the display unit 10 (Step 204, reduction object rendering).

The control unit 30 renders these objects in the field of view V at a predetermined frame rate. The frame rate is not particularly limited, and is, for example, 30 to 60 fps. Accordingly, it is possible to smoothly cause the object to move.

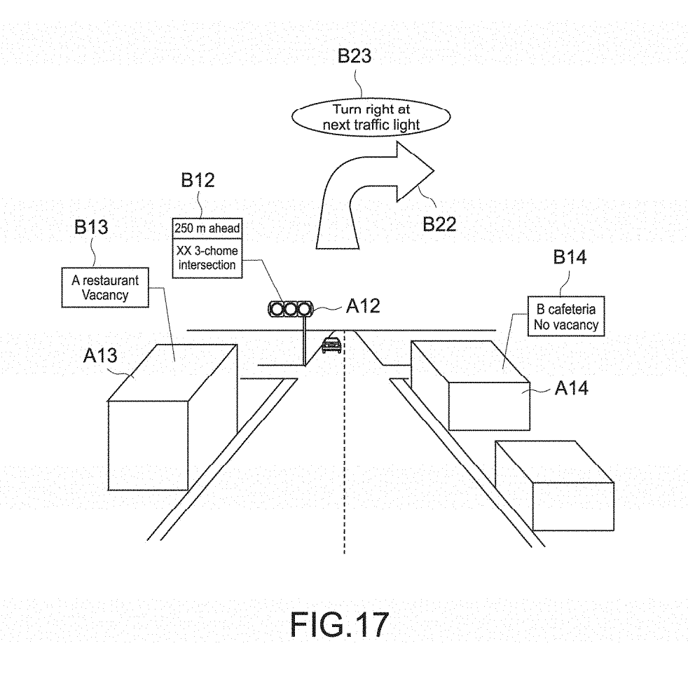

FIG. 17 is a schematic diagram of the field of view V, which describes an example of application of a car navigation application to the HMD 100.

On the field of view V (display area 110) of the display unit 10, various objects relating to specific target objects A12, A13, and A14 viewed by a user from a car he/she is riding are displayed. Examples of the specific target object include a traffic light (A12), restaurants (A13, A14), and the like. As related objects B12, B13, and B14 including information relating thereto, an intersection name (traffic light name) (B12), shop names and vacancy information (B13, B14), and the like, are displayed. Further, examples of an individual object B22 including information relating to a route to a destination include an arrow sign indicating the traveling direction.

On the related objects B12 to B14, display control is performed by the above-mentioned normal object rendering. Therefore, the related objects B12 to B14 are caused to move, on the basis of the output of the position information acquisition unit 207 of the portable information terminal 200, in the field of view V in the direction (backward in the figure) opposite to the traveling direction of the vehicle depending on the running speed of the vehicle the user is riding. Further, also in the case where the user shakes his/her head to look around the circumference, similarly, the related objects B12 to B14 are caused to move, on the basis of the output of the detection unit 20, in the field of view V in the direction opposite to the movement direction of the display unit 10 by the same movement amount as the movement amount of the display unit 10. Accordingly, since the related objects B12 to B14 respectively follow the specific target objects A12 to A14, the user is capable of easily determining the correspondence relationship between the specific target objects A12 to A14 and the related objects B12 to B14.

Meanwhile, typically, the individual object B22 is displayed at a predetermined position (e.g., slightly above the central part) in the field of view V, and the display content is updated on the basis of the output of the position information acquisition unit 207 of the portable information terminal 200, a road map data acquired from the server N, and the like, depending on the traveling direction of the user, the road environment, and the like. In this case, for example, as shown in the figure, such display control that character information (B23) or the like is also displayed in addition to the arrow sign (B22) to cause the user to pay attention when the traffic signal at which the user is to turn right comes closer may be executed.

On the individual object B22, display control is performed by the above-mentioned reduction object rendering. Therefore, since the movement of the individual object B22 in the field of view V corresponding to the movement of the display unit 10 is reduced, the individual object B22 is prevented from moving to the outside of the field of view V even in the case where the movement amount of the display unit 10 is relatively large, e.g., the user shakes his/her head to look around the circumference. Accordingly, it is possible to improve the visibility and searchability of the individual object B22 to be presented to the user U.

As described above, according to this embodiment, since the related object including information relating to the specific target object is caused to move by the same amount as the movement amount of the display unit 10 so as to follow the corresponding specific target object, it is possible to easily acquire information relating to the specific target object.

Meanwhile, according to this embodiment, since the movement amount of the individual object that is not related to the specific target object is reduced to the movement amount smaller than the movement amount of the display unit 10, it is possible to reduce the possibility of moving to the outside of the field of view V and ensure stable visibility or searchability. Further, for example, since the individual object does not move or finely shake meaninglessly so as to follow user's unconscious (unintended) movement, it is possible to suppress the variability of the visibility due to the user.

### Second Embodiment

Next, a second embodiment of the present technology will be described. Hereinafter, configurations that are different from those according to the first embodiment will be mainly described, a description of the same configurations as those according to the above-mentioned embodiment will be omitted or simplified.

In this embodiment, for example, an example in which the present technology is applied to a menu screen, pattern authentication screen, or the like of the function of the HMD 100 will be described.

### Application Example 1

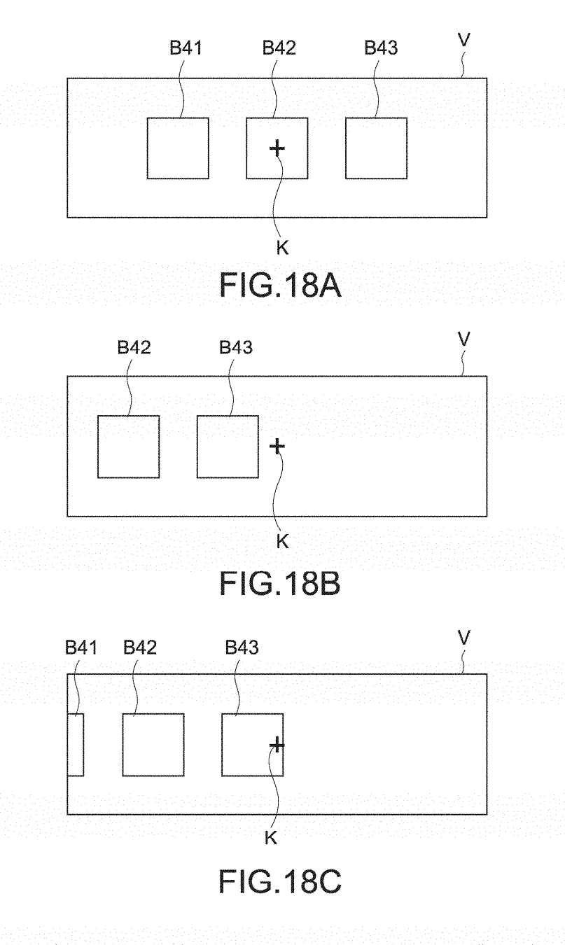

FIGS. 18A to 18C are each a schematic diagram of the field of view V, which shows an example of a menu screen of the function of the HMD 100 as an AR object (individual object).

As shown in FIG. 18A, in the field of view V (display area 110) of the display unit 10, for example, three menu images B41 to B43 are arranged in the right-and-left direction at a predetermined pitch. For example, icons of individual applications (game, movie, navigation system, information display, and the like) correspond to these menu images B41 to B43. The user causes a cursor K fixedly displayed at the center of the field of view to move to a desired menu image by rotating his/her head (display unit 10) in the right-and-left direction, and selects the menu image by executing a predetermined input command (e.g., input operation on the input operation unit 305 of the control unit 30).

In the case of selecting the menu screen B43 on the right side when executing the above-mentioned input operation (head tracking), the user causes the menu image B43 to move to the center of the field of view V by rotating his/her head to the right. At this time, in the case where the movement amount of the menu screen B43 (movement amount of the cursor K) is the same as the movement amount of the display unit 10, since the movement amount of the menu image B43 is too large as shown in FIG. 18B, it is difficult to cause it to properly move in some cases, e.g., it jumps to the left from the position of the cursor K at the center.

In this regard, the HMD 100 according to this embodiment includes the display control unit 314 (see FIG. 6) that executes reduction control of reducing the movement amount of each of the menu images B41 to B43 (movement amount of the cursor K) to be smaller than the movement amount of the display unit 10. Accordingly, as shown in FIG. 18C, it is possible to bring the cursor K into alignment with the desired menu image, and improve the pointing operability at the time of head tracking. Further, since the movement amount of each of the menu images B41 to B43 is smaller than the movement amount of the display unit 10, the user does not lose sight of the individual menu image while moving, which makes it possible to ensure the visibility or searchability of each menu image.

### Application Example 2

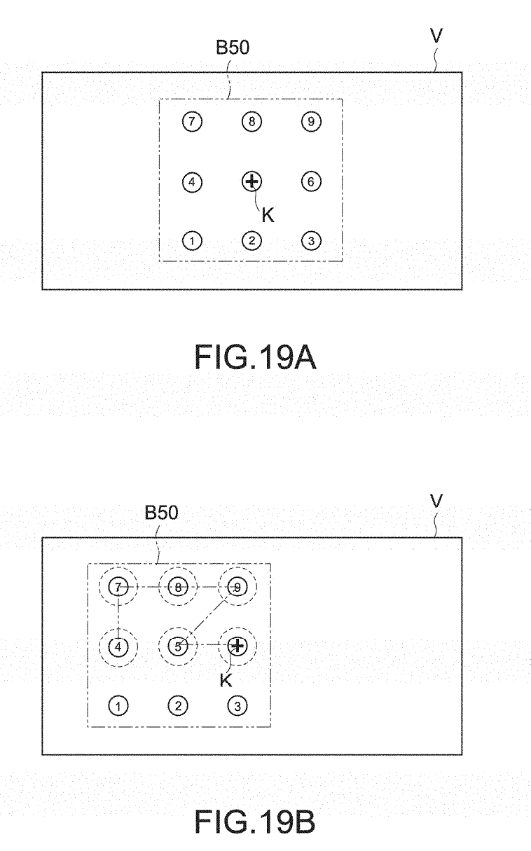

Next, FIGS. 19A and 19B are each a schematic diagram of the field of view V on which a pattern authentication screen B50 is displayed as an AR object (individual object). On the pattern authentication screen B50, an image in which a plurality of keys (or radio buttons) of “1” to “9” are arranged in a matrix pattern is displayed so that the keys are caused to integrally move in the field of view V depending on the up-and-down direction and the right-and-left direction of the user's head. Then, by bringing predetermined keys into alignment with the cursor K displayed at the center of the field of view V in a predetermined order as shown in FIG. 19B, an authentication password including a plurality of digits is input.

Also in this example, similarly, the display control unit 314 is configured to execute reduction control of reducing the movement amount of the pattern authentication screen B50 to be smaller than the movement amount of the display unit 10. Accordingly, it is possible to accurately and reliably perform pattern authentication.

Note that when causing the cursor K to move to the initial position (first key), it is possible to cause the cursor K (screen) to move in the area between the keys. Alternatively, by detecting that a predetermined input operation is executed at an initial position of the cursor K, the cursor position may be determined as the initial position.

### Application Example 3

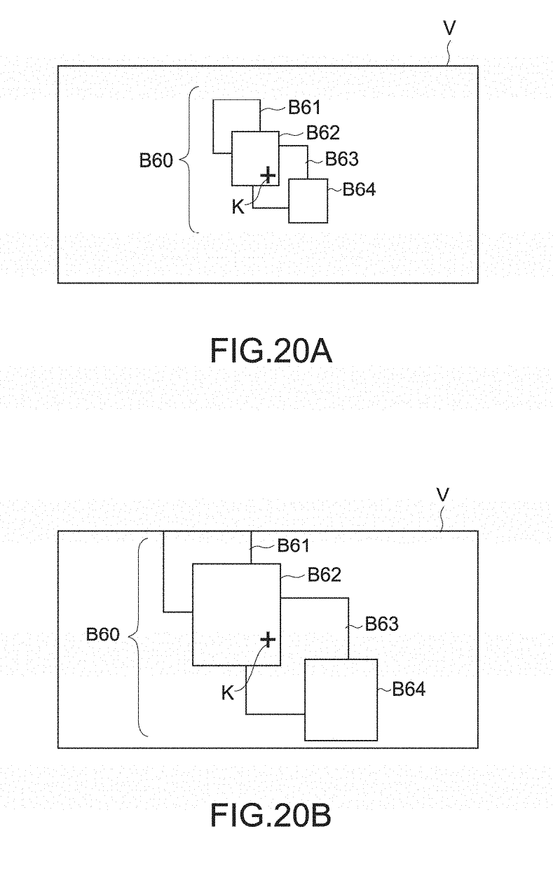

FIGS. 20A and 20B are each a schematic diagram of the field of view V, which shows the state where a user selects a specific object from a selection screen B60 in which a plurality of objects (B61 to B64) are closely spaced to partially overlap with each other. In this example, an enlarging/reducing operation of the selection screen B60 and a moving operation of the selection screen B60 with respect to the cursor K can be performed. The former operation is executed by a predetermined input operation of the input operation unit 305 of the control unit 30, a moving operation of the display unit 10 in the front-back direction, or the like, and the latter operation is executed by a moving operation of the display unit 10.

Also in this example, similarly, the display control unit 314 is configured to execute reduction control of reducing the movement amount of the selection screen B60 to be smaller than the movement amount of the display unit 10 in the case where the enlarging operation is executed. Accordingly, the user is capable of reliably and easily selecting a predetermined desired object from the plurality of closely-spaced objects B61 to B64.

Although embodiments of the present technology have been described heretofore, the present technology is not limited to only the above-mentioned embodiments, and it goes without saying that various modifications can be made without departing from the essence of the present technology.

For example, in the embodiments described above, an example in which the present technology is applied to the HMD has been described. However, the present technology is applicable also to, for example, an image display apparatus such as a head-up display (HUD) installed in the driver's seat of a vehicle or a cockpit of an airplane or the like as an image display apparatus other than the HMD.

Further, in the embodiments described above, an example of application to the see-through (transmissive) HMD has been described. However, the present technology is applicable also to a non-transmissive HMD. In this case, it only needs to display a predetermined object according to the present technology in the outside field of view imaged by a camera attached to the display unit.

Further, in the embodiments described above, as a wearable display, the HMD attached to the user's head has been described as an example. However, the present technology is not limited thereto, and is applicable also to, for example, a display apparatus that is attached to the user's arm, wrist, or the like for use or a display apparatus that is directly attached to an eye ball, such as a contact lens.

It should be noted that the present technology may take the following configurations.

(1) A wearable display, including:

a display unit configured to be attachable to a user, the display unit including a display area that provides a field of view in real space to the user;

a detection unit that detects orientation of the display unit around at least one axis; and

a display control unit configured to be capable of presenting a first image relating to the orientation in the display area on the basis of an output of the detection unit, and causing, depending on a change in the orientation, the first image to move in the display area in a direction opposite to a movement direction of the display unit by a first movement amount smaller than a movement amount of the display unit.

(2) The wearable display according to (1) above, in which

the display control unit controls the first movement amount such that the first image is in the display area.

(3) The wearable display according to (1) or (2) above, in which

the display control unit controls the first movement amount such that the first movement amount is gradually reduced as the first image approaches an outside of the display area.

(4) The wearable display according to any one of (1) to (3) above, in which

the first image includes information relating to a route to a destination set by the user.

(5) The wearable display according to any one of (1) to (3) above, in which

the first image is a pattern authentication screen in which a plurality of keys are arranged in a matrix pattern.

(6) The wearable display according to any one of (1) to (3) above, in which

the first image includes a plurality of objects arranged in the display area, the user being capable of selecting the plurality of objects.

(7) The wearable display according to any one of (1) to (6) above, in which

the display control unit is configured to be capable of presenting a second image in the display area on the basis of the output of the detection unit, the second image including information relating to a specific target object in real space in the orientation, and causing, depending on the change in the orientation, the second image to move in the display area in the direction opposite to the movement direction of the display unit by a second movement amount larger than the first movement amount.

(8) An image display apparatus, including:

a display unit including a display area;

a detection unit that detects orientation of the display unit around at least one axis; and

a display control unit configured to be capable of presenting a first image relating to the orientation in the display area on the basis of an output of the detection unit, and causing, depending on a change in the orientation, the first image to move in the display area in a direction opposite to a movement direction of the display unit by a first movement amount smaller than a movement amount of the display unit.

(9) An image display system, including:

a display unit including a display area;

a detection unit that detects orientation of the display unit around at least one axis;

a display control unit configured to be capable of presenting a first image relating to the orientation in the display area on the basis of an output of the detection unit, and causing, depending on a change in the orientation, the first image to move in the display area in a direction opposite to a movement direction of the display unit by a first movement amount that is equal to or smaller than a movement amount of the display unit; and

a reduction setting unit that sets the first movement amount.

### REFERENCE SIGNS LIST

10 display unit
20 detection unit
30 control unit
100 head-mounted display (HMD)
110 display area
200 portable information terminal
210 reduction attribution setting unit
314 display control unit
A1 to A4, A12 to A14 specific target object
B1 to B4, B10 to B14 related object
B20 to B23 individual object
V field of view

1. A wearable display, comprising:
a display unit configured to be attachable to a user, the display unit including a display area that provides a field of view in real space to the user;
a detection unit that detects orientation of the display unit around at least one axis; and
a display control unit configured to be capable of presenting a first image relating to the orientation in the display area on the basis of an output of the detection unit, and causing, depending on a change in the orientation, the first image to move in the display area in a direction opposite to a movement direction of the display unit by a first movement amount smaller than a movement amount of the display unit.

2. The wearable display according to claim 1, wherein
the display control unit controls the first movement amount such that the first image is in the display area.

3. The wearable display according to claim 1, wherein
the display control unit controls the first movement amount such that the first movement amount is gradually reduced as the first image approaches an outside of the display area.

4. The wearable display according to claim 1, wherein
the first image includes information relating to a route to a destination set by the user.

5. The wearable display according to claim 1, wherein
the first image is a pattern authentication screen in which a plurality of keys are arranged in a matrix pattern.

6. The wearable display according to claim 1, wherein
the first image includes a plurality of objects arranged in the display area, the user being capable of selecting the plurality of objects.

7. The wearable display according to claim 1, wherein
the display control unit is configured to be capable of presenting a second image in the display area on the basis of the output of the detection unit, the second image including information relating to a specific target object in real space in the orientation, and causing, depending on the change in the orientation, the second image to move in the display area in the direction opposite to the movement direction of the display unit by a second movement amount larger than the first movement amount.

8. An image display apparatus, comprising:
a display unit including a display area;
a detection unit that detects orientation of the display unit around at least one axis; and
a display control unit configured to be capable of presenting a first image relating to the orientation in the display area on the basis of an output of the detection unit, and causing, depending on a change in the orientation, the first image to move in the display area in a direction opposite to a movement direction of the display unit by a first movement amount smaller than a movement amount of the display unit.

9. An image display system, comprising:
a display unit including a display area;
a detection unit that detects orientation of the display unit around at least one axis;
a display control unit configured to be capable of presenting a first image relating to the orientation in the display area on the basis of an output of the detection unit, and causing, depending on a change in the orientation, the first image to move in the display area in a direction opposite to a movement direction of the display unit by a first movement amount that is equal to or smaller than a movement amount of the display unit; and
a reduction setting unit that sets the first movement amount.
